(19) United States
(12) Patent Application Publication
(10) Pub. No.: US 2005/0061718 A1
(43) Pub. Date: Mar. 24, 2005

(54) System for desalination and distribution of saline raw water

(76) Inventors: Curt Lindhe, Havdhem (SE); Lennart Castwall, Akersberga (SE)

Correspondence Address: YOUNG & THOMPSON, 745 SOUTH 23RD STREET, 2ND FLOOR, ARLINGTON, VA, 22202, US

(21) Appl. No.: 10/502,121

(22) PCT Filed: Jan. 17, 2003
(86) PCT No.: PCT/SE03/00073

(30) Foreign Application Priority Data
Jan. 18, 2002 (SE) 0200135-2

(51) Int. Cl. B01D 17/12

(52) U.S. Cl. 210/96.2; 210/257.2; 210/195.2; 210/259

(57) ABSTRACT

It has now been shown that it is possible to produce, at low cost, water for house-hold use from saline raw water with the aid of a system which provides water with at least two different salt contents. Saline raw water is transported to a pre-desalination unit which reduces the salt content down to a predetermined level, but not to the low level required for drinking water. This utility water can be used as it is, for flush toilets, washing, dishwashing, watering, etc. A portion of the utility water is transported to a fine desalination unit for production of drinking water. A portion of used utility water and drinking water can also be returned to the pre-desalination unit for production of new utility water.

This invention relates to a new system for distribution and purification/desalination of water to the final user, the raw water being saline. The invention also relates to a process for purification and desalination of saline raw water for producing drinking water and utility water to the final user.

### BACKGROUND

Freshwater is becoming a scarce commodity particularly in arid countries and/or those with rapidly growing populations. Due to environmental pollution, previously used freshwater sources can no longer be used for drinking Water. In many countries, particularly in North Africa, the Middle East and parts of Asia, lack of water is already acute. A number of European countries, e.g. Poland, Belgium, Great Britain, Germany, Denmark and Spain are approaching a situation where there is not enough freshwater.

Most of the world's water is to be found in the oceans. Due to its high salt content, seawater cannot be used directly in households without first removing the salt.

There are many methods of removing salt from seawater. By distilling seawater, the salts and pollutants can be effectively removed. However, the energy consumption is rather high and moreover there are problems with salt deposits in the equipment. Another alternative is to use ion exchangers. However, the amount of salt in sea-water is so great that the capacity of normal ion exchangers is insufficient. A consequence of this is that an unacceptably large amount of work must be devoted to re-generation of ion exchangers. Electro-dialysis is another alternative, but the energy cost is high. Finally, various membrane-filtering processes, such as reverse osmosis, can be used. For these, however, the energy cost is unacceptably high.

There is thus a need for an improved and less expensive method of producing water for household use starting from seawater or other saline water.

### SUMMARY OF THE INVENTION

It has now proved possible to produce, at low cost, water for household use from saline raw water with the aid of a system which produces water with at least two different salt contents. Saline raw water is transported to a pre-desalination unit, which reduces the salt content down to a predetermined level, but not down to that level which is required for drinking water. This utility water can be used as it is, in flush toilets, washing machines, dishwashers, for watering plants, etc. A portion of the utility water is transported to a fine desalination unit for production of drinking water. Some used utility water and drinking water can also be returned to the pre-desalination unit for production of new utility water.

Definitions

The term “raw water” used here relates to naturally occurring saline water, such as seawater, brackish water, water from salt seas and saline well water. Water designated “raw water” in this application has such a high saline content that, without further treatment, it cannot be used as drinking water. Typically, raw water has a salt content of between 0.5 and 4.5% by weight.

The term “utility water” used here relates to raw water which has been passed through a pre-desalination unit, removing a large proportion of the salts of the raw water. The water, which is designated “utility water” in this application, has however such a high salt content that, without further treatment, it cannot be used as drinking water. Typically, utility water has a salt content of between 0.3 and 2% by weight.

The term “final user” used here refers to a water subscriber, such as a household or a company.

The term “pre-desalination unit” used here relates to an apparatus which can remove a major proportion of the salts in raw water, to thereby produce utility water. A pre-desalination unit according to this invention can be an electro-dialysis device or a nano-filter.

The term “fine desalination unit” used here relates to a device which can almost completely remove salts dissolved in water. A fine desalination unit according to the invention is a filter which uses reverse osmosis.

The term “drinking water” used here relates to water which has a salt content low enough that a person can drink it without problems. Typically, drinking water has a salt content of about 0.02-0.05%.

### FIGURES

The invention will now be described below in more detail with reference to the accompanying drawings, of which

FIG. 1 shows a diagrammatic outline of a system according to the invention;

FIG. 2 shows a diagrammatic outline of the test plant which was used for membrane filtration with nano-filters and reverse osmosis; and

FIGS. 3 and 4 show diagrammatic outlines of additional systems according to the invention.

### DETAILED DESCRIPTION OF THE INVENTION

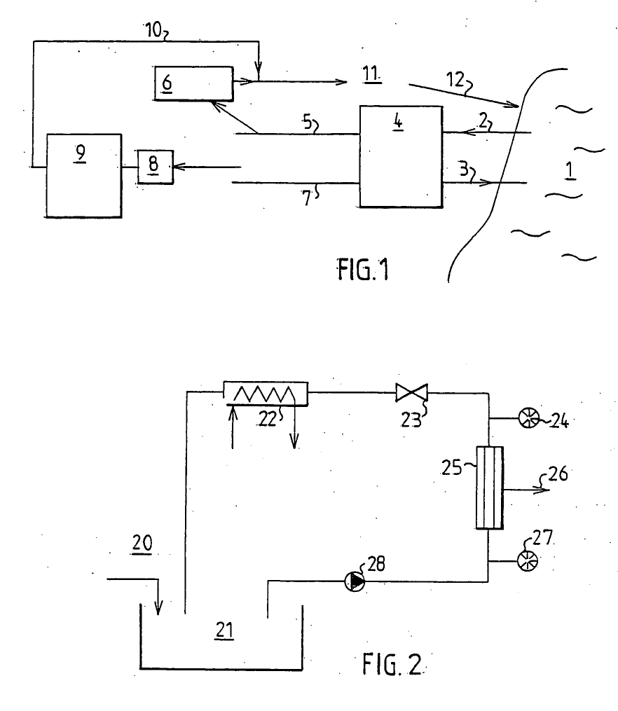

This invention relates to the treatment of seawater or other saline raw water. The invention provides a system of pre-desalinating raw water which is then distributed to the final users. This utility water can be used directly for certain purposes, such as in toilets, washing machines, dishwashers and for certain types of watering. In order to obtain drinking water, the utility water is finally desalinated with a separate fine de-salination unit. FIG. 1 shows a diagrammatic outline of such a system.

The raw water from a raw water source 1, e.g. seawater, is transported to a pre-desalination unit 4 through a conduit 2. In this unit 4, the raw water is divided into two fractions, utility water with lower salt content and residual water with higher salt content than the raw water. The residual water is returned to the raw water source 1 through the conduit 3. The utility water is divided up into two separate circuits. The major portion, more than 50% and preferably more than 65%, is transported via a conduit 5 to small salt-sensitive points of use at the final users. Such small salt-sensitive points of use 6 can be toilets, washing machines, etc. From these points of use 6, the used utility water is transported to a water treatment plant 11 from which it is transported back to the raw water source 1 via a conduit 12. A minor portion of the utility water, at most 50% and preferably less than 35%, is transported via the conduit 7 to a fine desalination unit 8 for production of drinking water. This drinking water is transported to the final users 9. In the same manner as for the utility water, used drinking water 10 is sent back to a water treatment plant 11 and is transported therefrom finally to the raw water source 1 through the conduit 12. In the experimental work, the pre-desalination unit consists of a nano-filter (manufacturers listed in Table 1), while the fine desalination unit is a filter unit using reversed osmosis (RO-filter). In the membrane filtering trials, test water was pumped from a work tank through the membrane module and thereafter returned to the work tank. The principle for the test installation is shown in FIG. 2. Untreated saline water 20 is poured into a work tank 21. Water from the work tank 21 was transported with the aid of a pump 28 to a membrane module 25. This membrane module was, in some of the experiments, a nano-filter (pre-desalination arrangement) and in other experiments it was an RO-filter (fine desalination arrangement). Permeate 26 which, depending on the set-up, can be utility water or drinking water, is tapped from the membrane module 25 when it is pressure-loaded. The pressure drop over the membrane is measured with the aid of two manometers 24 and 27 on either side of the membrane module 25. The flow through the membrane module is regulated by a throttle valve 23. The flow is finally conducted through the heat exchanger 22 to keep the temperature constant before it is led back to the work tank 21.

The tests were thus performed with both nano-filtering membranes and with RO-filters. As a pre-treatment method, the nano-filtering membranes are primarily of interest while the results from the tests with RO-filtering can be used as a reference. The tests were carried out with nano-filtering membranes of various salt-removing characteristics. The different membrane types used in the trials are listed in Table 1.

All of the trials were carried out at an average pressure over the membrane surface of 3.0 MPa and at a temperature of 20° C.

TABLE 1
Membrane data

| | | | Salt | |
|---|---|---|---|---|
| | Manu- | | removal, | Membrane |
| Membrane | facturer | Type/Design | % NaCl | surface, m² |
| AFC 50 | PCI (GB) | nano/tube | 50 | 0.9 |
| AFC 80 | PCI (GB) | nano/tube | 80 | 0.9 |
| TFC S4921 | Fluid Systems | nano/spiral | 85 | 7.2 |
| | (US) | | | |
| SC 2540 | Desal (US) | RO/spiral | 99 | 1.6 |

In Tables 2 and 3 below, chloride contents in zero-tests (untreated water) and in water treated with the various membrane types, are shown. The table also shows the conductivity of the water and flux. The values for flux given are those obtained under stable operational conditions after about one day's operation.

TABLE 2
Baltic seawater, salt content 0.6%

| | Cl⁻, | Conductivity, | Flux, |
|---|---|---|---|
| Sample | mg/l | mS/cm | l/m², h |
| Zero sample | 3300 | 9.2 | |
| Permeate, AFC 50 | 1500 | 4.2 | 98 |
| Permeate, TFCS 4921 | 1100 | 3.3 | 46 |
| Permeate, SC 2540 | 29 | 0.1 | 9.4 |

TABLE 3
Mediterranean seawater, salt content 4.0%

| | Cl⁻ | Conductivity | Flux |
|---|---|---|---|
| Sample | mg/l | mS/cm | l/m², h |
| Zero sample | 22000 | 43 | |
| Permeate, AFC 50 | 12000 | 26 | 67 |
| Permeate, AFC 80 | 10000 | 22 | 16 |
| Permeate, SC 2540 | 640 | 2.1 | 3.3 |

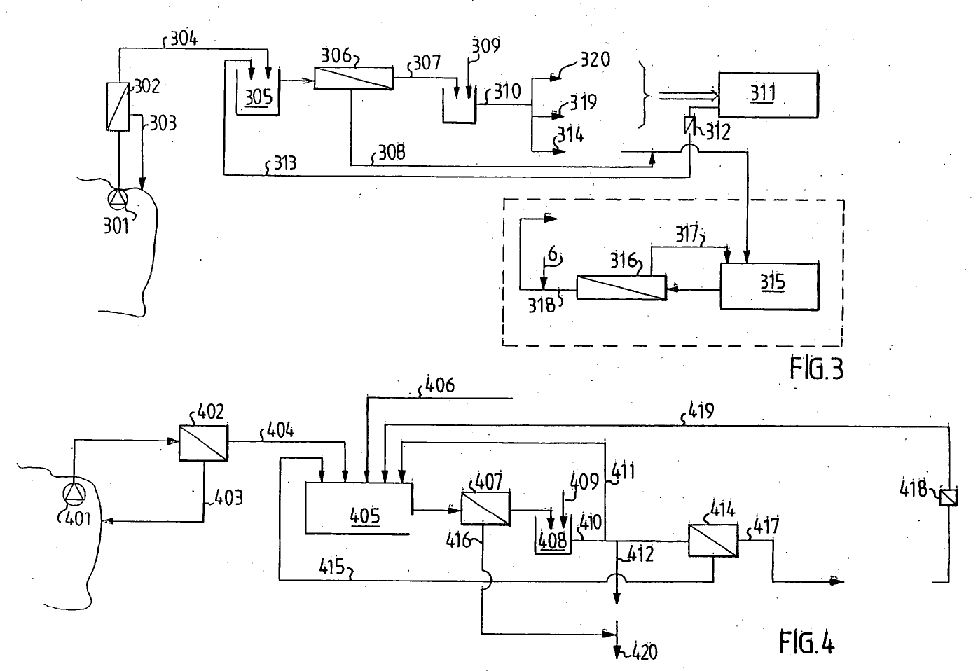

FIG. 3 illustrates an additional embodiment of the system according to the invention. Raw water (seawater) 301 is pumped up to a nano-filter 302. The concentrate from the nano-filter is pumped back into the sea through the conduit 303. Permeate, or utility water, from the nano-filter 301 is transported through conduit 304 to a utility water tank 305. The utility water is transported to an RO-filter 306. The permeate or drinking water from the RO-filter is led via pipe 307 to a chlorination plant 309. The water from the chlorination plant 309 is led through the feeder conduit 310 to households for use in cooking 320, bathing/dishwashing/shower/washing machine/sink 319 and toilet 314. Water which has been used for cooking 320, and bathing/dishwashing/shower/washing machine/sink 319 is collected in a buffer tank 311 and is transported via a filter 312 through the pipe 313 to the utility water tank 305 for reuse. Concentrate from the RO-filter 306 is pumped via the conduit 308 and is joined by the sewage from toilets 314 to the municipal water treatment plant 315. Water from this treatment plant 315 can then be transported to a nano-filter 316. The permeate can be used in toilets or for watering. The concentrate from the nano-filter 316 is recirculated to the treatment plant 315 through the conduit 317.

Below there is a computation of the energy consumption for a plant as configured in FIG. 3 with a capacity of 100 m³/day, which corresponds to 200 households. In this case, AFC 80 (PCI, GB) was used as nano-filter 302 och SC 2540 (Desal, US) as RO-filter 306.

Assume that toilets and evaporation account for circa 25% of the amount of water supplied. Assume also that the raw water has a salt content of 40 g/l. The rest of the water is collected and recirculated, which means that only 25 m³ of raw water/day needs to be supplied to the system. With an energy consumption of circa 4 kWh/M³, the energy consumption in nano-filter 302 will thus be 100 kWh/day. On the other hand, the RO-unit processes 100 m³ of utility water/day due to the recirculation. The salt content of the utility water introduced into the RO-unit will then be 5 g/l. The energy consumption for this is 100 m³ times 2 kWh/m³, which gives 200 kWh. The total energy consumption will thus be roughly 300 kWh/day. In this alternative, drinking water is also used for showering/bathing and for the toilets. Spiral-wound membranes are used. The nano-filtering membrane has a capacity of 40 l/M² and h, which results in a membrane surface of 27 m² for a flow of 25 m³/day. The RO-filter membrane has a capacity of 15 l/M² and hour, and has a membrane surface of 290 m² for 100 m³/day.

FIG. 4 shows an alternative embodiment of a system according to the invention. Raw water is transported from a raw water source 401 to a first nano-filter 402. The concentrate from the first nano-filter 402 is returned to the raw water source through the conduit 403. The permeate is led to a buffer tank 405 through the conduit 404. Possibly, rain water from a collecting means 406 can also be added to the buffer tank 405. From the buffer tank 405, water is transported to a second nano-filter 407 for production of utility water. The utility water or permeate is led to a chlorination unit 409. The concentrate from the second nano-filter goes to a municipal water treatment plant 420 through conduit 416. The chlorinated utility water is divided up into flows to a) RO-filter 414; b) bath/shower/dishwasher/washing machine 411; and c) toilet. Utility water which has been used for bath/shower/dishwasher/washing machine 411 is led back to buffer tank 405. Utility water which has been used in toilets 412 goes to the municipal treatment plant 420. The permeate from the RO-filter 414 is used as drinking water and for cooking and, when used, the water passes the filter 418 and the conduit 419 to come to the buffer tank 405. Concentrate from the RO-filter 414 is returned to the buffer tank 405 through conduit 415.

The two nano-filters 402 and 407 have in this case a membrane surface of 109+72=181 m². As regards the RO-unit 414, a membrane surface of 17 m² is required. In this case AFC 80 (PCI, GB) was used as nano-filters 402 and 407 and SC 2540 (Desal, US) was used as RO-filter 414.

For estimating the energy consumption for this system, the same assumptions are made as in the previous example. Toilets and evaporation account for 25% of the water amount supplied. The supply of rainwater is negligible. The raw water has a salt content of 40 g/l. The rest of the water is collected and recirculated, which means that only 25 m³ of raw water/day need be supplied to the system. With an energy consumption of 4 kWh/m³, the energy consumption in nano-filter 402 will thus be 100 kWh/day. On the other hand, the nano-filter 407 processes 100 m³ of utility water/day due to recirculation. The salt content of the utility water introduced into the RO-unit 414 will then be 2 g/l. The energy consumption for this is 100 m³ times 1.5 kWh/M³, which results in 150 kWh/day. In this case only 6 m³/day will pass through the RO-unit 414. The energy consumption for this will be 6 m³/day times 2.5 kWh/M³, which will be 15 kWh/day. Total energy consumption will thus be roughly 265 kWh/day.

This can be compared with the alternative of allowing the raw water to pass directly through the RO-filter for production of drinking water. In this case the energy consumption would be 5 kWh/m³, which means that 500 kWh are consumed to produce 100 m³ of drinking water.

1. System for distribution and purification/desalination of saline raw water with an original salt content U to a final user and possibly taking care of waste water from said final user, wherein the system comprises:
a) at least one pre-desalination unit which, from raw water, produces utility water;
b) at least one fine desalination unit with a capacity for producing drinking water from the utility water; and
c) conduits for transport of i) raw water from the raw water source to the pre-desalination unit(s); and ii) conduits for transport of utility water from the pre-desalination unit to the fine desalination unit(s); where the water fed into the fine desalination unit is either utility that has passed through a desalination unit or is recirculated consumed utility water or drinking water from final users, charactererised in that A) the utility water has a salt content X which is lower than U but higher than Y, where Y represents the highest salt content which is acceptable for drinking water, and B) conduits for transporting utility water and drinking water, respectively, to the final user.

2. System according to claim 1, characterized in that less than 50%, preferably less than 33% of the utility water is transported to a fine desalination unit for production of drinking water, whereafter the drinking water is transported to final users and the rest of the utility water is transported directly to final users.

3. System according to claim 1, characterized in that at least 30%, preferably at least 50% of the used utility water and/or drinking water which has not been used for toilets, is returned to the pre-desalination unit for production of new utility water.

4. System according to claim 1, characterized in that the system comprises two pre-desalination units, coupled in series, possibly with a buffer tank between them.
